(19) United States
(12) Patent Application Publication
(10) Pub. No.: US 2024/0291640 A1
(43) Pub. Date: Aug. 29, 2024

(54) SYSTEMS AND METHODS FOR QUANTUM KEY DISTRIBUTION SECURED VAULT-BASED APPLICATION-TO-APPLICATION COMMUNICATION

(71) Applicant: JPMORGAN CHASE BANK, N.A., New York, NY (US)

(72) Inventors: Omar AMER, New York, NY (US); John S. COMBS, Fallston, MD (US); Albert HUANG, Singapore (SG); Andrew LANG, Avon, CT (US); Charles LIM, Singapore (SG); Marco PISTOIA, Amawalk, NY (US)

(21) Appl. No.: 18/174,768

(22) Filed: Feb. 27, 2023

(51) Int. Cl. H04L 9/08; H04B 10/70

(52) U.S. Cl. CPC H04L 9/0852; H04B 10/70; H04L 9/0819; H04L 9/085; H04L 9/0891

(57) ABSTRACT

Systems and methods for quantum key distribution (QKD) secured vault-based application-to-application communication are disclosed. A method may include: receiving, at a vault application at a first facility, a request for a shared quantum key for communication of a secret in a vault at the first facility to an application at a second facility; distilling, by quantum devices at the first and the second facility and over a quantum communication channel, a shared quantum key using a QKD protocol; receiving, by an encryptor at the first facility, the secret; encrypting, by the encryptor at the first facility, the secret with the shared quantum key, communicating, the encrypted secret to the second facility over a communication network; decrypting, by an encryptor at the second facility, the encrypted secret with the shared quantum key; and receiving, by the application at the second facility, the secret from the encryptor at the second facility.

### BACKGROUND OF THE INVENTION

### 1. Field of the Invention

Embodiments relate to systems and methods for quantum key distribution secured vault-based application-to-application communication.

### 2. Description of the Related Art

Vaults, or Cloud Hardware Security Modules, are systems that may be used to strictly regulate access to secrets, such as API keys, encryption keys, passwords, and certificates. The vault system can enable users and other applications to delegate storage and control of their secrets securely, with access to the secrets being enabled through the vault's user interface, command line interface, or application programming interface (API). Access through these interfaces can be strictly controlled and restricted, ensuring that secrets are only released to authorized parties on a fine-grained basis, as well as allowing for auditing of secret accesses.

Vault systems are generally deployed in one of three architectures: self-hosted, cloud-hosted, and third-party-hosted—the third of which can be considered as a special instance of the second. In each case, communication between hosts in a vault cluster and the user are communicated using public key cryptography primitives, exposing a potential vulnerability in the case of a quantum-enabled attacker or potential post-quantum cryptographic failures.

To ensure that the vault contents remain secure in the case of a data-breach, the data may be encrypted at rest using an encryption key that is also encrypted and stored on the system. The encryption key is itself encrypted using a root key, which may be distributed to trusted parties or, for additional security, individual cryptographic shares of the root key can be distributed. These cryptographic shares may be constructed using a secret sharing scheme, such as the Shamir's Secret Sharing scheme, that ensures that any sufficiently large number of parties can recover the root key and decrypt the vault, but smaller groups cannot, thereby limiting the risk of a malicious actor recovering the root key.

Examples of potential vulnerabilities against attackers with the ability to break public key cryptography include the harvesting of secrets in-transit from the vault to the user; the stealing of portions of the encrypted database during database replication; and when transferred to enable decryption of the database, the leakage of cryptographic shares of the root key.

### SUMMARY OF THE INVENTION

Systems and methods for quantum key distribution secured vault-based application-to-application communication are disclosed. In one embodiment, a method for quantum key distribution and secured vault-based application-to-application communication may include: (1) receiving, at a vault application at a first facility, a request for a shared quantum key for communication of a secret stored in a vault at the first facility to an application at a second facility; (2) distilling, by a quantum device at the first facility and a quantum device at the second facility and over a quantum communication channel, a shared quantum key using a quantum key distribution protocol; (3) receiving, by an encryptor at the first facility, the secret from the vault; (4) encrypting, by the encryptor at the first facility, the secret with the shared quantum key, wherein the encrypted secret is communicated to the second facility over a communication network; (5) decrypting, by an encryptor at the second facility, the encrypted secret with the shared quantum key; and (6) receiving, by the application at the second facility, the secret from the encryptor at the second facility.

In one embodiment, the quantum communication channel comprises a direct fiber optic communication channel between the quantum device at the first facility and the quantum device at the second facility.

In one embodiment, the encryptor at the first facility comprises shared onboard module to a router.

In one embodiment, the communication network comprises the Internet.

In one embodiment, the application at the second facility is configured to encrypt or decrypt data with the secret.

In one embodiment, the method may also include replacing, by the quantum device at the first facility and the quantum device at the second facility and over a quantum communication channel, the shared quantum key.

In one embodiment, the application at the second facility comprises a second vault application executed by a vault server cluster at the second facility.

In one embodiment, the first facility and the second facility are within the same data center or location.

According to another embodiment, a system may include: a first facility comprising a vault server cluster, a first quantum device, and a first encryptor; a second facility comprising a second quantum device, a second encryptor, and an application. A vault application executed by the vault server cluster receives a request for a shared quantum key for communication of a secret stored in a vault at the first facility to an application at a second facility. The first quantum device and the second quantum device distill a shared quantum key over a quantum communication channel using a quantum key distribution protocol. The first encryptor receives the secret from the vault and encrypts the secret with the shared quantum key. The second encryptor receives the encrypted secret over a communication network and decrypts the encrypted secret with the shared quantum key. And the application at the second facility receives the secret from the encryptor at the second facility.

In one embodiment, the quantum communication channel comprises a direct fiber optic communication channel between the quantum device at the first facility and the quantum device at the second facility.

In one embodiment, the encryptor at the first facility comprises shared onboard module to a router.

In one embodiment, the communication network comprises the Internet.

In one embodiment, the application at the second facility is configured to encrypt or decrypt data with the secret.

In one embodiment, the first quantum device and the second quantum device refresh the shared quantum key over the communication channel.

In one embodiment, the application at the second facility comprises a vault server cluster at the second facility.

In one embodiment, the first facility and the second facility are within the same data center or location.

According to another embodiment, a method for encrypting cryptographic shares of a root key with a shared quantum key may include: (1) encrypting, by a vault application at a vault server cluster at a first facility, a vault key with a root key; (2) storing, by the vault application, the vault key; (3) distilling, by a quantum device at the first facility and with quantum devices at each of a plurality of key share facilities over a plurality of quantum communication channels, shared quantum keys; (4) receiving, by an encryptor at the first facility, a plurality of cryptographic shares of root key; (5) encrypting, by the encryptor at the first facility, each share of the plurality of cryptographic shares of the root key with the shared quantum key for the key share facility; and (7) communicating, by the encryptor at the first facility, the encrypted plurality of root key cryptographic shares to the respective key share facility over a communication network, wherein each of the key share facilities is configured to store the encrypted root key share.

In one embodiment, the method may also include receiving, by the vault application over the communication network, the encrypted root key cryptographic shares from the key share facilities; decrypting, by the vault application, the encrypted root key cryptographic shares; reconstructing, by the vault application, the root key from the root key cryptographic shares; and decrypting, by the vault application, the vault key with the root key.

In one embodiment, contents of a vault are encrypted with the vault key.

In one embodiment, the quantum communication channels comprise direct fiber optic communication channels between the quantum device at the first facility the quantum devices at each of the key share facilities, and the communication network comprises the Internet.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for quantum key distribution secured vault-based application-to-application communication according to an embodiment;

FIG. 2 illustrates a method for quantum key distribution secured vault-based application-to-application communication according to an embodiment;

FIG. 3 depicts a method for encrypting cryptographic shares of a root key with a shared quantum key according to an embodiment;

FIG. 4 depicts a method for quantum-secured communication by an endpoint according to an embodiment;

FIG. 4 depicts a method for quantum-secured application-to-application communication according to an embodiment;

FIG. 5 depicts a method for quantum-secured communication between endpoints using a vault as an intermediary according to an embodiment;

FIG. 6 depicts an exemplary computing system for implementing aspects of the present disclosure.

### DETAILED DESCRIPTION OF PREFERRED EMBODIMENTS

Embodiments relate to systems and methods for quantum key distribution secured vault-based application-to-application communication.

In embodiments, users of a vault (e.g., users on a corporate network) may deploy quantum key distribution connections, such as quantum communication channels, between their facilities and the facilities containing vault servers. For example, vault servers may be hosted on private data centers (owned by the company themselves), on cloud service provider data centers, etc.

Each facility, system, etc. may be provided with one or more quantum devices that may communicate via a quantum channel (e.g., direct fiber optic, satellite, distributed quantum entanglement, etc.). The quantum devices may engage in a quantum key distribution protocol to distill a shared quantum key. The shared quantum key may be provided to encryptors or similar devices at each facility to enable high-speed secure communications between the facilities.

The shared quantum key may be distilled for each communication. In another embodiment, the shared quantum key may be used for a plurality of communications. The shared quantum key may be re-distilled after a certain number of communications, after a period of time, or as otherwise necessary and/or desired.

Communications involving secrets encrypted with the shared quantum key may occur over a classical communication network, such as fiber optic, ethernet, the Internet, etc. Examples of such communications include transfers of secrets from vault to user, transfer of credentials from user to vault, etc.

Private and cloud service provider data centers, including vault servers, may also be connected via quantum communication channels.

The shared quantum keys may be provided to a cloud key management service, which may be used to securely communicate with both other data centers and other networks.

Embodiments may also secure the communication between primary and secondary vault nodes, thereby mitigating the risk that the encrypted database or parts of it thereof may be leaked during, for example, replication.

Embodiments may also secure communication between users of the vault and applications after they receive necessary tokens from the vault servers to access.

In embodiments, quantum key distribution may enable unconditionally secure authentication with the vault server by locally authenticating users before using quantum key distribution-enabled symmetric key authentication protocols. Any suitable authentication method may be used, including username and password, biometric authentication, out-of-band authentication, multifactor authentication, etc.

The use of a shared quantum key to secure a secret provides robust security against leakage of the secret in transit, during vault replication, or at rest. The enhanced security of the quantum key versus classical key exchange mechanisms is due to the unconditionally secure nature of quantum key distribution protocols, which leverage the principles of quantum physics to enable key-exchange that remains secure even against computationally unbounded attackers, a feat that cannot be replicated through classical means. such as public key infrastructure (PKI).

The shared quantum-secured access to the vault by endpoints enables the establishment of secret keys between endpoints that do not share a direct quantum channel in a method akin to the use of trusted nodes in the literature. This sharing of secret keys by the vault enables application-to-application or user-to-application with the same guarantees as the quantum-secure communication when the keys are used as part of application layer protocols, such as versions of TLS able to ingest pre-shared keys.

In some embodiments, when there are direct quantum channels between the facilities hosting applications (or a user and an application) such as when the application is co-hosted with a vault server, the vault may be bypassed and quantum keys may be fed directly to each of the encryption devices, thereby facilitating communication between applications.

A notable example of either instance is when one application is the secrets manager for a cloud provider, which may be similar in function to a vault cluster server. The methods may provide an independent quantum secure communication channel with the cloud provider (or with other applications).

Embodiments may integrate quantum key distribution-secured application-to-application communications between connected participants through the use of a quantum communication channel between an application and a vault server cluster, such as a one or more vaults and/or vault servers, as well as between another application or a user and a vault. For example, a session key may be securely shared between each of the parties connected to the vault cluster server (e.g., between a user and the vault cluster server) by using the quantum communication channel as a trusted intermediary.

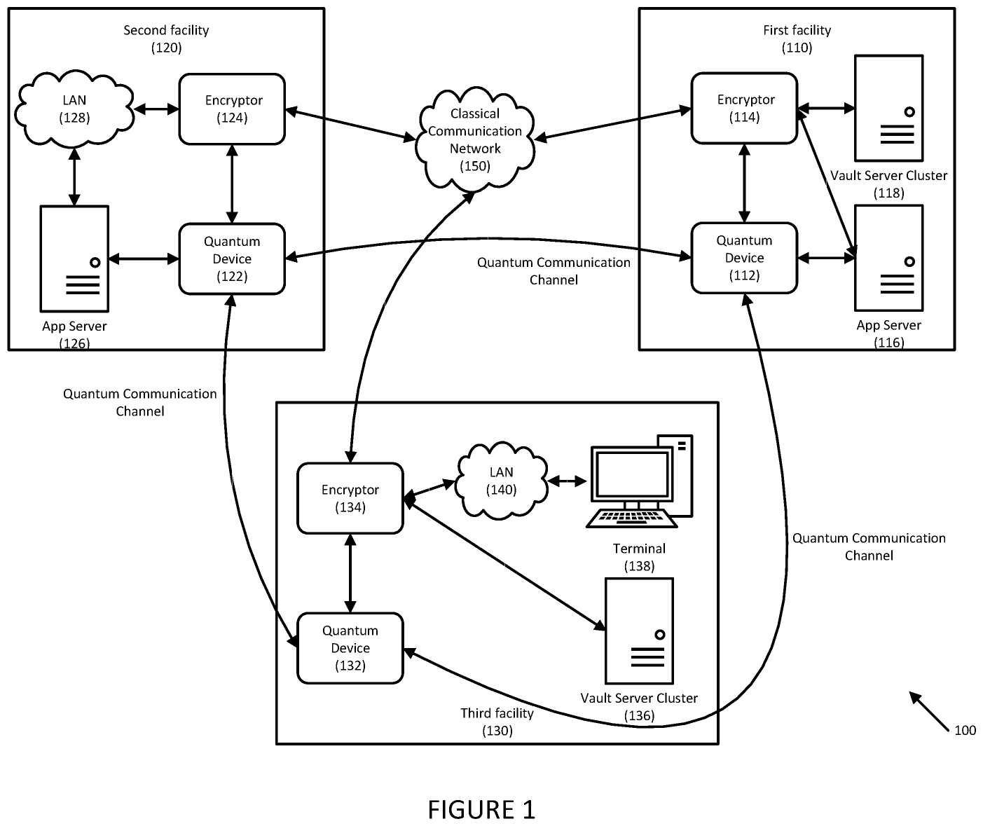

Referring to FIG. 1, a system for quantum key distribution secured vault-based application-to-application communication is disclosed according to an embodiment. System 100 may include a plurality of facilities, such as first facility 110, second facility 120, and third facility 130. Although three facilities are illustrated in FIG. 1, it should be recognized that a greater number or fewer number of facilities may be provided as is necessary and/or desired.

Facilities 110, 120, 130 may be, for example, cloud environments, private networks (e.g., corporate networks), public cloud data centers, private data centers, etc. In one embodiment, facilities 110, 120, 130 may be within the same data center, cloud provider, etc.

In one embodiment, different equipment within a single facility or location may be considered to be multiple facilities. For example, a first facility may include a first server and the second facility may include a second server, and these may be within the same location. The equipment may communicate using the shared quantum key encryption protocols disclosed herein to protect data in transit between the equipment.

Each facility 110, 120, 130 may be provided with a quantum device (e.g., 112, 122, 132), and quantum devices 112, 122, 132 may communicate over quantum communication channels, such as fiber optic channels, satellite channels, etc. Examples of quantum devices 112, 122, 132 may include commercial quantum key distribution appliances, quantum key distribution transmitter and receivers hardware, or other hardware capable of establishing keys using a quantum key distribution protocol. Quantum devices 112, 122, 132 may implement a quantum key protocol, such as BB84, E91, Device Independent Quantum Key Distribution, Twin Fields Quantum Key Distribution, to distill a shared quantum key. For example, the shared quantum key must be private and identical, properties that are ensured using the various quantum key distribution protocols.

Each facility 110, 120, 130 may be provided with an encryptor (e.g., 114, 124, 134), which may encrypt and decrypt data, such as data from vault server cluster 118, with the shared quantum key. Encryptors 114, 124, 134 may be local area network (LAN) encryptors, or wide area network (WAN) encryptors. For example, encryptors 114, 124, 134 may be an appliance or process that ingests key material and data and encrypts the data using an encryption scheme (e.g., AES256-GCM). In embodiments, instead of a dedicated encryptor, the functions may be achieved at the application layer (e.g., in software at the vault applications/API).

In one embodiment, encryptors 114, 124, 134 may be shared onboard modules to a router (not shown) that may communicate and/or receive the encrypted data. In another embodiment, encryptors 114, 124, 134 may maybe software-based, may be part of vault server clusters (e.g., 118, 116), may be part of an application or application server (e.g., 116, 126), etc.

Encryptors 114, 124, 134 may communicate encrypted data, such as the secret encrypted with the shared quantum key, over classical communication network 150, which may include classical communication channels, such as optical fiber links, ethernet, the Internet, etc. For example, a device at facility 110, 120, 130, such as application (“app”) servers (e.g., 116, 126), vault server cluster (e.g., 118, 136), terminal (e.g., 138) may provide a message to its respective encryptor 114, 124, 134 which may encrypt the message with the shared quantum key and communicate it to the destination encryptor which may decrypt the message with the shared quantum key.

Vault server clusters 118, 136 may include one or more vaults, and may execute vault applications or computer programs (not shown) that may control the access to vault contents in the vault, such as secrets. Examples of secrets include keys, session identifiers, sensitive data, API keys, passwords, certificates, etc.

Application servers 116, 126 may host computer applications and programs at their respective facilities. The computer programs may use the secret to encrypt and decrypt other data that may be communicated among two or more facilities, to store data at rest, etc.

In one embodiment, vault server cluster 118, 136 may distribute cryptographic shares of the key (i.e., cryptographic shares of the root key, which is what is eventually used to decrypt and encrypt the vault in its entirety) to some set of configured parties such as applications, other vaults, users, etc. The cryptographic shares may be encrypted with the shared quantum key.

LANs 128 and 140 may provide local area networking within facilities 120 and 130 that may facilitate communications among devices at the respective facility. First facility 110 may also include a LAN (not shown).

Vault server cluster 136 may provide system 100 with a second vault system. For example, secrets in vault server cluster 118 may be replicated in vault server cluster 136. During replication, secrets from vault server cluster 118 may be encrypted with the shared quantum key, and decrypted before being stored in vault 136.

Terminal 138, which may be a computer (e.g., workstation, desktop, laptop, notebook, tablet, etc.), a smart device (e.g., smart watch, smart phone, etc.), an Internet of Things (IoT) appliance, etc. that may consume data once it is decrypted with the secret.

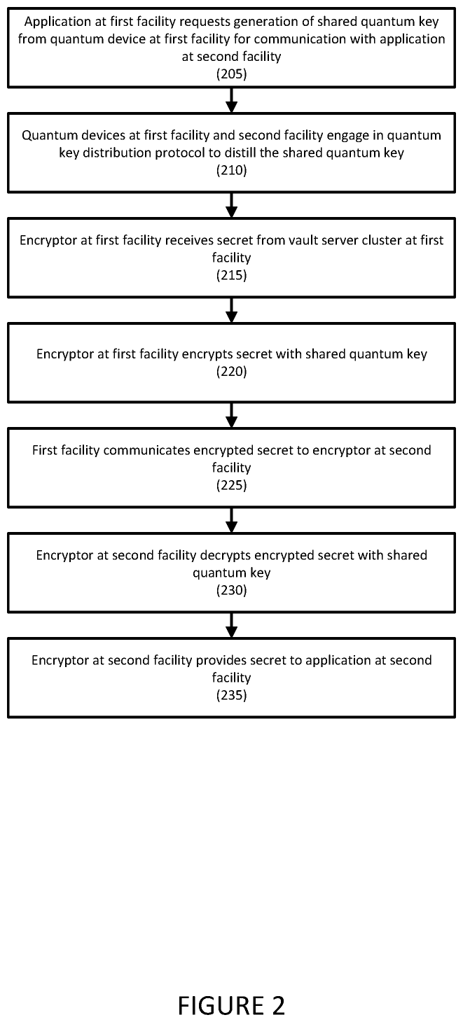

Referring to FIG. 2, a method for quantum key distribution secured vault-based application-to-application communication is disclosed according to an embodiment.

In step 205, an application may request the generation of a shared quantum key by a quantum device at a first facility for communication with an application at a second facility. For example, the application may be an application executed by an application server, a vault computer program, a program executed by an end user device, etc. The application may be at the first facility or the second facility.

A vault computer program or application executed by the vault server cluster may receive the request.

The shared quantum key may be requested to encrypt a secret that may be stored in a vault at the first facility so it can be securely communicated from the first facility to the second facility.

In one embodiment, the first facility and the second facility may be within the same data center, cloud provider, etc.

In one embodiment, the request may be an API request, and may include proper authentication from the requestor (e.g., credentials, information-theoretic secure message authentication using shared quantum keys from another vault system, etc.).

In step 210, quantum devices at the first facility and the second facility may engage in a quantum key distribution protocol to distill the shared quantum key. The quantum devices may interact over a quantum communication channel, such as a fiber optic channel, a satellite channel, etc. The quantum communication channel may be a direct communication channel between the quantum devices. Once distilled, each quantum device may maintain the shared quantum key or it may be passed to a key management service of an auxiliary device.

The shared quantum key may be continuously refreshed or replaced, and may be used for communication with a variable refresh rate (e.g., used to feed AES256 encryption with a key/second refresh rate, or one-time-pad with single use keys).

In step 215, an encryptor at the first facility may receive the secret from a vault server cluster at the first facility. The secret may be a key or any other data that access to is to be tightly controlled. The encryptor may be, for example, a shared onboard module to a router.

In step 220, the encryptor at the first facility may encrypt the secret with the shared quantum key, and in step 225, the first facility, such as the encryptor, may communicate the encrypted secret to an encryptor at the second facility. The communication may be over a classical communication network, which may include classical communication channels, such as optical fiber links, ethernet, the Internet, etc.

In one embodiment, the classical communication network may abstract away standard networking and communication methods (e.g., the use of routers, switches, optical communication devices, etc.).

In step 230, the encryptor at the second facility may use the shared quantum key from the quantum device at the second facility to decrypt the encrypted secret.

In step 235, the encryptor at the second facility may provide the secret to an application at a second facility. The application may then store the secret in a vault server cluster, may use the secret to encrypt or decrypt other data, etc.

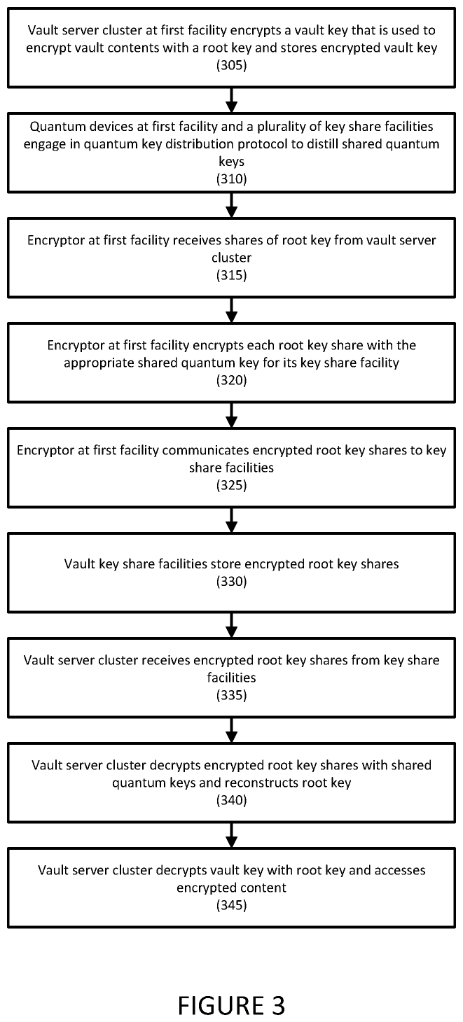

Referring to FIG. 3, a method for encrypting cryptographic shares of a root key with a shared quantum key is disclosed according to an embodiment. In order to reduce the risk of secrets being leaked in the case of a breach of a vault server, in some embodiments, vault server clusters may store their contents in an encrypted fashion, such as by using a vault key to encrypt the data. In order to recover the vault contents, the vault key must be stored somewhere to be accessed when needed. For example, the vault key may itself be encrypted with an additional root key The encrypted vault key may be stored with the vault data and the root key may be either distributed to some number of trusted parties, or, for additional security, the root key may be split into a plurality of root key cryptographic shares. The cryptographic shares may be distributed to the trusted parties.

For example, using a secret sharing scheme (e.g., Shamir's Secret Sharing), embodiments may construct n cryptographic shares of the root key and each cryptographic shares may be distributed to a different party. The cryptographic shares may be constructed in such a way that for some chosen threshold t<n, any group of t+1 cryptographic shares is sufficient to reconstruct the secret, whereas any group of t or fewer cryptographic shares betrays no information on the value of the secret. Note that the case where the root key itself is distributed rather than secret shared is equivalent to a t=0 secret sharing. To access the vault data, t+1 parties send their cryptographic shares to the vault server, which reconstructs the root key, uses it to decrypt the vault key, and uses the vault key to decrypt the data.

By secret sharing the root key, the vault ensures that an attacker must have learned some t+1 cryptographic shares as well as the encrypted contents of the vault (including the encrypted vault key). Thus, the shared quantum key may be used to encrypt the key cryptographic shares to the parties, thereby reducing the risk of the shares being intercepted in transit.

In step 305, a computer program or application executed by a vault server cluster at a first facility may encrypt a vault key with a root key, and may store the encrypted vault key. In one embodiment, the vault key may be used to encrypt the contents of the vault.

In step 310, quantum devices at the first facility and at a plurality of key share facilities may engage in quantum key distribution protocol to distill shared quantum keys. This may be similar to step 210, above, except that each key share facility will have its own shared quantum key with the first facility.

The number of key share facilities may be selected based on the number of cryptographic shares of the root key that will be generated, where the number of cryptographic shares distributed and the number of cryptographic shares necessary to recover the root key are set by the user configuration.

In step 315, an encryptor at the first facility may receive the cryptographic shares of the root key from vault server cluster, and in step 320, the encryptor at first facility may encrypt each root key share with the shared quantum key for its key share facility, again reducing the risk of shares being intercepted in transit.

In step 325, the encryptor at the first facility may communicate the encrypted root key cryptographic shares to the key share facilities.

In step 330, the key share facilities may store encrypted root key cryptographic shares in any suitable manner.

In step 335, when the vault server cluster needs to access data in the vault, the vault server cluster may receive the encrypted root key cryptographic shares from the key share facilities. As noted above, not all encrypted root key cryptographic shares are needed to reconstruct the root key, but as described above, t+1 encrypted root key cryptographic shares are needed.

In step 340, the vault server cluster may decrypt the received encrypted root key cryptographic shares with the respective shared quantum keys and may reconstruct the root key from the root key cryptographic shares.

In step 345, the vault server cluster may decrypt the vault key with the root key, and may access encrypted content in the vault.

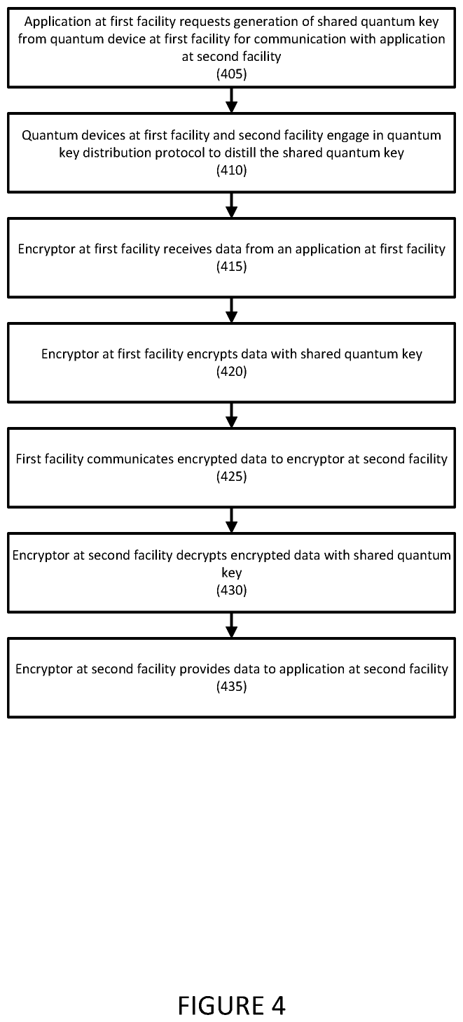

Referring to FIG. 4, a method for quantum-secured communication by an endpoint is disclosed according to an embodiment.

In step 405, an application may request the generation of a shared quantum key by a quantum device at a first facility for communication with an application at a second facility. This may be similar to step 205, above.

In step 410, quantum devices at the first facility and the second facility may engage in a quantum key distribution protocol to distill the shared quantum key. This may be similar to step 210, above.

In step 415, an encryptor at the first facility may receive data from an application at the first facility. The data may include any data that access to is to be tightly controlled. The encryptor may be, for example, a shared onboard module to a router.

In step 420, the encryptor at the first facility may encrypt the data with the shared quantum key, and in step 425, the first facility, such as the encryptor, may communicate the encrypted data to an encryptor at the second facility. The communication may be over a classical communication network, which may include classical communication channels, such as optical fiber links, ethernet, the Internet, etc.

In step 430, the encryptor at the second facility may use the shared quantum key from the quantum device at second facility to decrypt the encrypted data.

In step 435, the encryptor at the second facility may provide the data to an application at a second facility. The application may then store the secret in a vault server cluster, may use the secret to encrypt or decrypt other data, etc. The application may itself by a vault server cluster, or in some embodiments, may be a cloud secrets manager, enabling quantum-secured communications between the cloud and the first application.

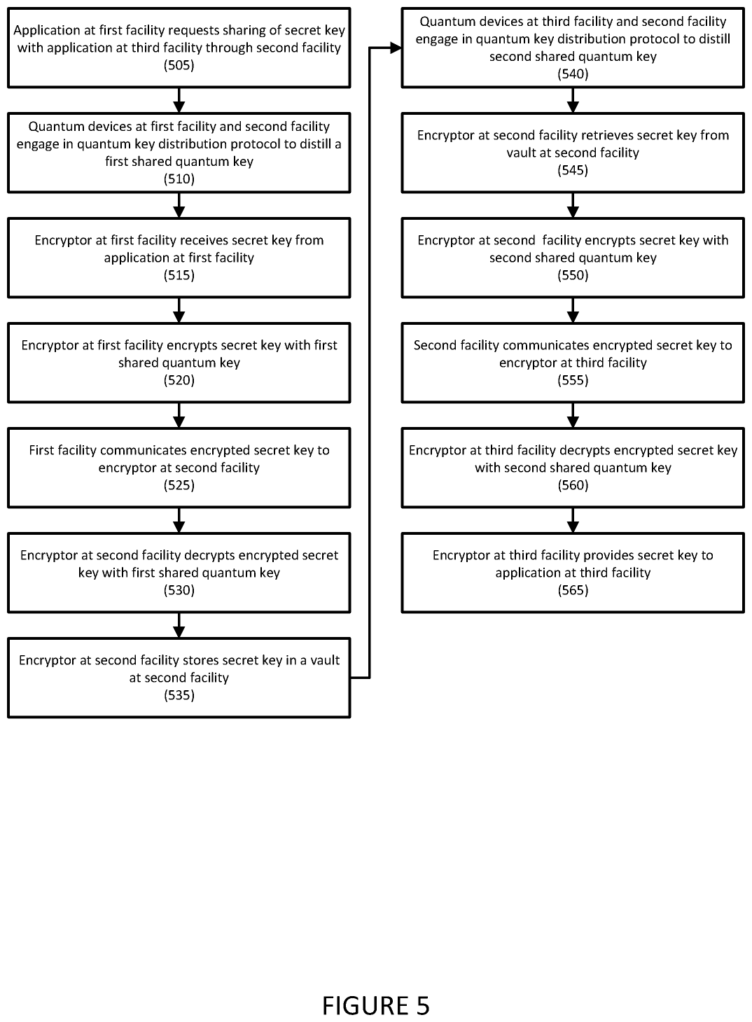

Referring to FIG. 5, a method for quantum-secured application-to-application communication is disclosed according to another embodiment. For example, a vault at a second facility may be used as a trusted intermediary to share a secret key between an application in the third facility. In embodiments, the process may be initiated by a message to the vault from the application in the first facility that instructs the vault to assist in the transmission of the secret key between the applications in the first facility and in the third facility. Through classical communication means, the two applications may decide they need to establish a secret key, and choose to do so through this method.

In step 505, a first application at a first facility may request sharing of secret key with a second application at third facility through a second facility. For example, the second application may be a cloud secret manager, or another embodiment of an application dedicated to managing secrets for a cloud service, such as another dedicated vault service.

In step 510, quantum devices at the first facility and the second facility may engage in a quantum key distribution protocol to distill a first shared quantum key. This may be similar to step 210, above.

In step 515, an encryptor at the first facility may receive a secret key from the application at the first facility.

In step 520, the encryptor at the first facility may encrypt the secret key with the first shared quantum key. This may be similar to step 220, above.

In step 525, the first facility may communicate the encrypted secret key to an encryptor at the second facility over a communication network. This may be similar to step 225, above.

In step 530, the encryptor at the second facility may decrypt the encrypted secret key with the first shared quantum key.

In step 535, the encryptor at the second facility may store the secret key in a vault at the second facility.

In step 540, quantum devices at the third facility and the second facility may engage in a quantum key distribution protocol to distill a second shared quantum key. This may be similar to step 210, above.

In step 545, the encryptor at the second facility may retrieve the secret key from a vault at the second facility.

In step 550, the encryptor at the second facility may encrypt the secret key with the second shared quantum key. This may be similar to step 220, above.

In step 555, the second facility may communicate the encrypted secret key to an encryptor at a third facility over a communication network. This may be similar to step 225, above.

In step 560, the encryptor at the third facility may decrypt the encrypted secret key with the second shared quantum key.

In step 565, the encryptor at the third facility may provide the secret key to application at the third facility.

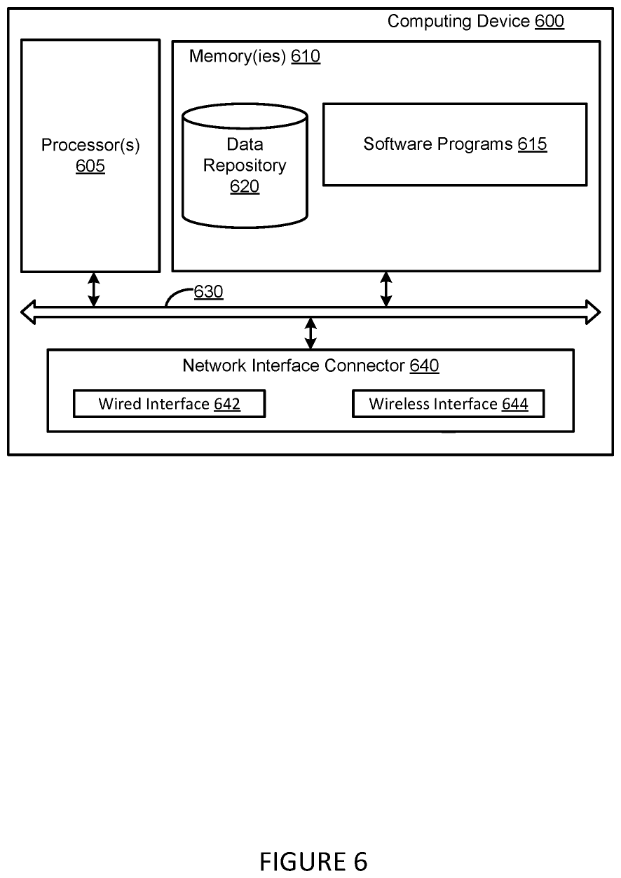

FIG. 6 depicts an exemplary computing system for implementing aspects of the present disclosure. FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for quantum key distribution and secured vault-based application-to-application communication, comprising:
receiving, at a vault application at a first facility, a request for a shared quantum key for communication of a secret stored in a vault at the first facility to an application at a second facility;
distilling, by a quantum device at the first facility and a quantum device at the second facility and over a quantum communication channel, a shared quantum key using a quantum key distribution protocol;
receiving, by an encryptor at the first facility, the secret from the vault;
encrypting, by the encryptor at the first facility, the secret with the shared quantum key, wherein the encrypted secret is communicated to the second facility over a communication network;
decrypting, by an encryptor at the second facility, the encrypted secret with the shared quantum key; and
receiving, by the application at the second facility, the secret from the encryptor at the second facility.

2. The method of claim 1, wherein the quantum communication channel comprises a direct fiber optic communication channel between the quantum device at the first facility and the quantum device at the second facility.

3. The method of claim 1, wherein the encryptor at the first facility comprises shared onboard module to a router.

4. The method of claim 1, wherein the communication network comprises the Internet.

5. The method of claim 1, wherein the application at the second facility is configured to encrypt or decrypt data with the secret.

6. The method of claim 1, further comprising:
replacing, by the quantum device at the first facility and the quantum device at the second facility and over a quantum communication channel, the shared quantum key.

7. The method of claim 1, wherein the application at the second facility comprises a second vault application executed by a vault server cluster at the second facility.

8. The method of claim 1, wherein the first facility and the second facility are within the same data center or location.

9. A system, comprising:
a first facility comprising a vault server cluster, a first quantum device, and a first encryptor;
a second facility comprising a second quantum device, a second encryptor, and an application;
wherein:
a vault application executed by the vault server cluster receives a request for a shared quantum key for communication of a secret stored in a vault at the first facility to an application at a second facility;
the first quantum device and the second quantum device distill a shared quantum key over a quantum communication channel using a quantum key distribution protocol;
the first encryptor receives the secret from the vault and encrypts the secret with the shared quantum key;
the second encryptor receives the encrypted secret over a communication network and decrypts the encrypted secret with the shared quantum key; and
the application at the second facility receives the secret from the encryptor at the second facility.

10. The system of claim 9, wherein the quantum communication channel comprises a direct fiber optic communication channel between the quantum device at the first facility and the quantum device at the second facility.

11. The system of claim 9, wherein the encryptor at the first facility comprises shared onboard module to a router.

12. The system of claim 9, wherein the communication network comprises the Internet.

13. The system of claim 9, wherein the application at the second facility is configured to encrypt or decrypt data with the secret.

14. The system of claim 9, wherein the first quantum device and the second quantum device refresh the shared quantum key over the communication channel.

15. The system of claim 9, wherein the application at the second facility comprises a vault server cluster at the second facility.

16. The system of claim 9, wherein the first facility and the second facility are within the same data center or location.

17. A method for encrypting cryptographic shares of a root key with a shared quantum key, comprising:
encrypting, by a vault application at a vault server cluster at a first facility, a vault key with a root key;
storing, by the vault application, the vault key;
distilling, by a quantum device at the first facility and with quantum devices at each of a plurality of key share facilities over a plurality of quantum communication channels, shared quantum keys;
receiving, by an encryptor at the first facility, a plurality of cryptographic shares of root key;
encrypting, by the encryptor at the first facility, each share of the plurality of cryptographic shares of the root key with the shared quantum key for the key share facility; and
communicating, by the encryptor at the first facility, the encrypted plurality of root key cryptographic shares to the respective key share facility over a communication network, wherein each of the key share facilities is configured to store the encrypted root key share.

18. The method of claim 17, further comprising:
receiving, by the vault application over the communication network, the encrypted root key cryptographic shares from the key share facilities;
decrypting, by the vault application, the encrypted root key cryptographic shares;
reconstructing, by the vault application, the root key from the root key cryptographic shares; and
decrypting, by the vault application, the vault key with the root key.

19. The method of claim 17, wherein contents of a vault are encrypted with the vault key.

20. The method of claim 17, wherein the quantum communication channels comprise direct fiber optic communication channels between the quantum device at the first facility the quantum devices at each of the key share facilities, and the communication network comprises the Internet.
